(19) United States
(12) Patent Application Publication
(10) Pub. No.: US 2011/0033011 A1
(43) Pub. Date: Feb. 10, 2011

(54) METHODS AND APPARATUSES RELATING TO MULTI-RESOLUTION TRANSMISSIONS WITH MIMO SCHEME

(75) Inventors: Ren-Jr Chen, Hsinchu City (TW); Chang-Lung Hsiao, Zhubei City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Industrial Technology Research Institute

(21) Appl. No.: 12/817,449

(22) Filed: Jun. 17, 2010

Related U.S. Application Data
(60) Provisional application No. 61/231,470, filed on Aug. 5, 2009.
(60) Provisional application No. 61/258,688, filed on Nov. 6, 2009.

(51) Int. Cl. H04L 27/36; H04L 27/00

(52) U.S. Cl. 375/298; 375/295; 375/316; 375/302

(57) ABSTRACT

A method of providing a multi-resolution transmission with a MIMO scheme may include employing a selected modulation scheme to generate a first data stream including basic information and a second data stream including both enhanced information and the basic information, and employing a modulation and multiple input/multiple output (MIMO) scheme to generate data for transmission. The data for transmission may employ a combination of spatial multiplexing and transmit diversity techniques. A corresponding apparatus is also provided. Another method of providing selective recovery of received data at a mobile terminal may include receiving data at a mobile terminal including at least one antenna, receiving information indicative of a data reception condition at the mobile terminal, determining, between spatial multiplexing and transmit diversity mode options, a reception mode to be employed for decoding the data received based on the information indicative of the data reception condition. A corresponding apparatus is also provided.

### CROSS REFERENCE TO RELATED APPLICATION

This application claims the benefit of U.S. Provisional Application No. 61/231,470, filed Aug. 5, 2009, and U.S. Provisional Application No. 61/258,688, filed Nov. 6, 2009, the contents of which are incorporated herein in their entirety.

### TECHNOLOGICAL FIELD

Embodiments of the present application relate generally to communication technology and, more particularly, relate to an apparatus and method for providing multi-resolution transmissions (e.g., MBMS (multimedia broadcast multicast service) transmissions) with a MIMO (multiple input, multiple output) scheme, and providing selective reception of such transmissions.

### BACKGROUND

In order to provide easier or faster information transfer and convenience, telecommunication industry service providers are continually developing improvements to existing networks. Multimedia Broadcast Multicast Service (MBMS) technology is a transmission paradigm that has been developed as a potential mechanism by which to provide broadcast transmission services to users. For example, for Long Term Evolution (LTE), special attention is being devoted to the support of MBMS which has already been standardized in 3GPP UTRAN (UMTS Terrestrial Radio Access Network) Release-6 and 7. In MBMS transmission, the design goal is to transmit increasing amounts of broadcasting information in a limited bandwidth and to support large groups of users with minimal power. For a mobile terminal or UE (user equipment) that has the capability to move to multiple places over time, however, changes in signal to interference plus noise ratio (SINR) can be expected among each UE at any time and for a given UE over time. If it is desirable for base stations (BSs) to support large groups of users, a robust modulation and coding scheme (MCS) should be applied to attempt to guarantee successful reception of data by UEs with low SINR. However, spectral efficiency may be sacrificed in some instances. Because there is often a trade-off in either service bit-rate or signal robustness, it may be difficult to provide MBMS to large groups of users with high spectral efficiency.

In a DVB-T (Digital Video Broadcasting—Terrestrial) system, hierarchical modulation is often applied to overcome the problem described above. In hierarchical modulation, two separate data streams are modulated onto a single stream. One stream, called the “high priority” (HP) stream or base information stream, may provide basic quality information. Meanwhile, another stream may be included that is referred to as a “low priority” (LP) stream or enhancement information stream providing higher quality information. UEs with high SINR reception conditions can receive both streams, while those with poorer SINR reception conditions may only receive the base information stream or “high priority” stream. Broadcasters can target two different types of DVB-T receiver with two completely different services. Typically, the LP stream is of a higher bitrate, but lower robustness than the HP stream. In some examples, a broadcaster could choose to deliver HDTV in the LP stream.

FIG. 1 is a block diagram showing the basic concept of hierarchical modulation. In this scheme, multi-media data is separated by source encoding (e.g., MPEG) into two information streams. One is a base information stream provided with basic quality information and the other is an enhancement information stream provided with higher quality information. The two separate information streams may be modulated onto a single stream by hierarchical modulation. FIG. 2 shows a hierarchical modulation scheme. In hierarchical modulation it is viewed as the combination of two QPSK (quadrature phase shift keying) while two remaining bits may be used to carry an enhancement information stream. As a result, the bit-rate of the two partial streams together may yield the bit-rate of 16-QAM (quadrature amplitude modulation) stream. Accordingly, in some cases, MBMS with hierarchical modulation can provide broadcasting service to suit UEs with various service environments.

MIMO technology has been used to increase the spectral efficiency or signal robustness depending on which mode is used. Spatial multiplexing (SM) mode is often used to increase spectral efficiency, while transmit diversity (T×D) mode is often used to increase signal robustness. For example, if BSs have two antennas, and UEs have two antennas, BSs can decide to use SM mode to double the spectral efficiency or T×D mode to increase the signal robustness. If BSs transmit a SM mode signal, UEs can decode the SM mode signal under two conditions. One condition is that the UEs are equipped with more than two antennas, and the other is that the SINR is high. On the other hand, UEs cannot decode the SM signal with one antenna or in low SINR. If BSs transmit a T×D mode signal, UEs can decode the T×D signal with more than one antenna or even in low SINR, but the spectral efficiency is half the spectral efficiency of the SM mode. There is also a trade-off between signal robustness and throughput.

### BRIEF SUMMARY

In view of the foregoing, example embodiments of the present application are therefore directed to a mechanism for providing multi-resolution transmission with a MIMO scheme. For example, some embodiments may provide for a new MIMO scheme that may be combined with hierarchical modulation concepts to adapt to different UE conditions, i.e. the number of antennas in the UE, or SINR at the UE.

In an exemplary embodiment, a method of providing multi-resolution transmission with a MIMO scheme is provided (“exemplary” as used herein referring to “serving as an example, instance or illustration”). The method may include employing hierarchical modulation to generate a first data stream including basic information and a second data stream including both enhanced information and the basic information, and employing a modulation and multiple input/multiple output (MIMO) scheme to generate data for transmission. The data for transmission may employ a combination of spatial multiplexing and transmit diversity techniques.

In another exemplary embodiment, an apparatus for providing multi-resolution transmission with a MIMO scheme is provided. The apparatus may include a processor. The processor may be configured to cause employing hierarchical modulation to generate a first data stream including basic information and a second data stream including both enhanced information and the basic information, and employing a modulation and multiple input/multiple output (MIMO) scheme to generate data for transmission. The data for transmission may employ a combination of spatial multiplexing and transmit diversity techniques.

In another exemplary embodiment, a method of selectively recovering data is provided. The method may include receiving data via at least one antenna at a mobile terminal, receiving information indicative of a data reception condition at the mobile terminal, determining, between spatial multiplexing and transmit diversity mode options, a reception mode to be employed for decoding the data received based on the information indicative of the data reception condition.

In another exemplary embodiment, an apparatus for selectively recovering data is provided. The apparatus may include a processor. The processor may be configured to cause receiving data via at least one antenna at a mobile terminal, receiving information indicative of a data reception condition at the mobile terminal, determining, between spatial multiplexing and transmit diversity mode options, a reception mode to be employed for decoding the data received based on the information indicative of the data reception condition.

### BRIEF DESCRIPTION OF THE SEVERAL VIEWS OF THE DRAWING(S)

Having thus described the application in general terms, reference will now be made to the accompanying drawings, which are not necessarily drawn to scale, and wherein:

FIG. 1 is a block diagram showing the basic concept of hierarchical modulation;

FIG. 2 shows a hierarchical modulation scheme;

FIG. 3 illustrates a block diagram of a structure of a MBMS scheme according to exemplary embodiments of the present application;

FIG. 4 illustrates a block diagram of a receiver structure according to an exemplary embodiment of the present application;

FIG. 5 illustrates a block diagram of a modulation scheme that may be employed according to an exemplary embodiment of the present application;

FIG. 6 illustrates a block diagram of a modulation scheme that may be employed according to another exemplary embodiment of the present application;

FIG. 7 illustrates a block diagram of a modulation scheme that may be employed according to yet another exemplary embodiment of the present application;

FIG. 8 illustrates a block diagram of a modulation scheme that may be employed according to still another exemplary embodiment of the present application;

FIG. 9 illustrates a block diagram of a modulation scheme that may be employed according to another exemplary embodiment of the present application;

FIG. 10 illustrates a block diagram of a modulation scheme that may be employed according to yet another exemplary embodiment of the present application;

FIG. 11 illustrates a block diagram of a modulation scheme that may be employed according to still another exemplary embodiment of the present application;

FIG. 12 illustrates a block diagram of a modulation scheme that may be employed according to yet still another exemplary embodiment of the present application;

FIG. 13 illustrates a block diagram of an apparatus for providing a multi-resolution transmission with a MIMO scheme according to an exemplary embodiment of the present application;

FIG. 14 illustrates a block diagram of an apparatus for providing selective recovery of received data at a mobile terminal according to an exemplary embodiment of the present application;

FIG. 15 is a flowchart including various steps in a method for providing a multi-resolution transmission with a MIMO scheme according to an exemplary embodiment of the present application; and

FIG. 16 is a flowchart including various steps in method for providing selective recovery of received data at a mobile terminal according to another exemplary embodiment of the present application.

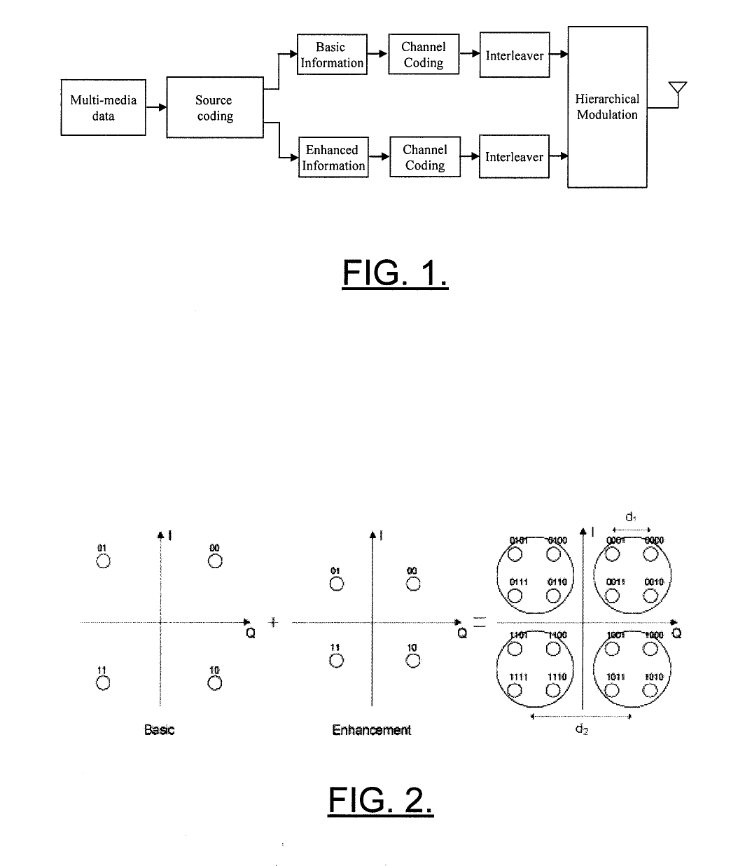

### DETAILED DESCRIPTION

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

As indicated above, MIMO technology and hierarchical modulation schemes have been employed in wireless communication networks to improve network performance. Some embodiments of the present disclosure may provide for an improved MIMO scheme that may be combined with hierarchical modulation concepts to adapt to different UE conditions. Accordingly, for example, with different numbers of antennas at a UE, or with different SINR conditions at the UE, performance may still be improved in a flexible way.

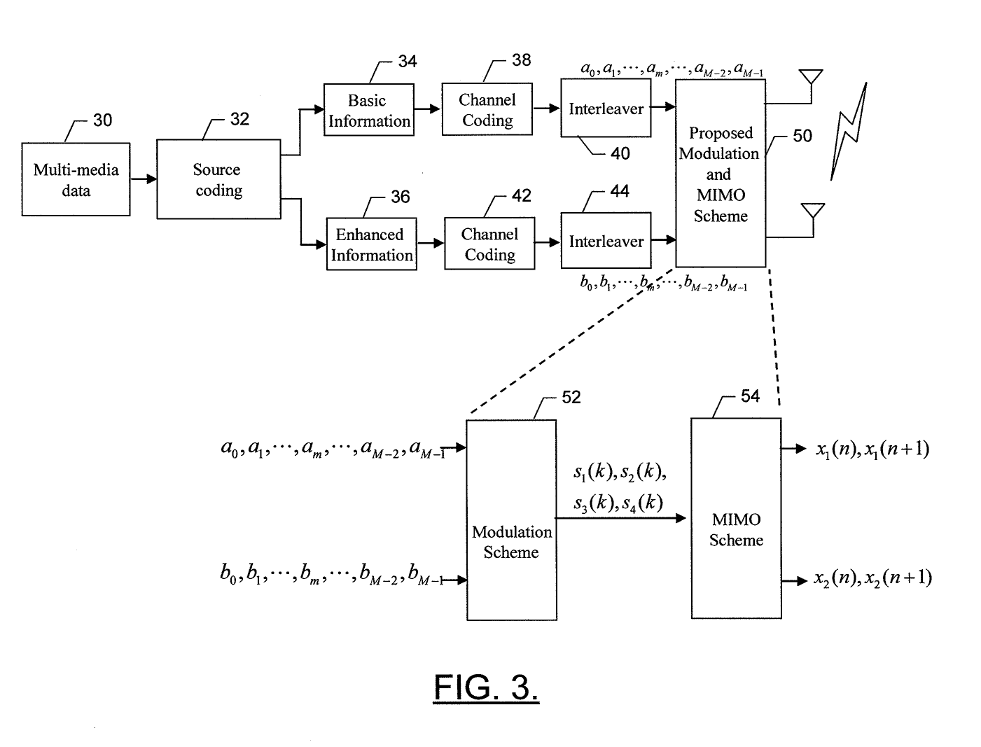

In an example embodiment, shown in FIG. 3, aspects of MIMO technology and hierarchical modulation may be combined in a flexible manner. As shown in FIG. 3, multimedia data 30 may initially be provided for source coding 32. Two data streams may be output responsive to source coding 32 including basic information 34 and enhanced information 36. The basic information 34 (or Iₘ) may be a high priority stream that provides basic quality information. The enhanced information 36 (or Eₘ) may be a low priority stream that provides higher quality information. The basic information 34 may be processed for channel coding 38 and be passed through an interleaver 40 to produce a data stream aₘ. The enhanced information 36 may be processed for channel coding 42 and be passed through an interleaver 44 to produce a data stream bₘ. The two data streams aₘ and bₘ may then be processed by a modulation and MIMO scheme 50 according to an example embodiment. More specifically, the two data streams aₘ and bₘ, which may comprise a₀, a₁, . . . , aₘ, . . . , aₘ₋₂, aₘ₋₁ and b₀, b₁, . . . , bₘ, . . . , bₘ₋₂, bₘ₋₁, respectively, may be processed via a modulation scheme 52 and a MIMO scheme 54.

Responsive to modulation using, for example, a hierarchical modulation scheme as described above (although another modulation scheme could be used as an alternative in some embodiments), the modulation and MIMO scheme 50 may perform modulation in accordance with the modulation scheme 52, and produce an output of s₁(k), s₂(k), s₃(k), s₄(k) in which s₁(k), s₂(k) corresponds to basic information and s₃(k), s₄(k) includes both basic information and enhanced information. Thereafter, the MIMO scheme 54 may employ one of a plurality of example mapping processes to provide for selective utilization of spatial modulation and transmit diversity for selectively providing benefits related to spectral efficiency and robust signal streams during selective recovery by the UE.

In an example embodiment, s₁(k) s₂(k) s₃(k) and s₄(k) may be the mappings from aₘ, aₘ₊₁, aₘ₊₂, aₘ₊₃, bₘ, bₘ₊₁, bₘ₊₂, bₘ₊₃, such that

s₁(k)=f₁(aₘ, aₘ₊₁, aₘ₊₂, aₘ₊₃, bₘ, bₘ₊₁, bₘ₊₂, bₘ₊₃),
s₂(k)=f₂(aₘ, aₘ₊₁, aₘ₊₂, aₘ₊₃, bₘ, bₘ₊₁, bₘ₊₂, bₘ₊₃),
s₃(k)=f₃(aₘ, aₘ₊₁, aₘ₊₂, aₘ₊₃, bₘ, bₘ₊₁, bₘ₊₂, bₘ₊₃) and
s₄(k)=f₄(aₘ, aₘ₊₁, aₘ₊₂, aₘ₊₃, bₘ, bₘ₊₁, bₘ₊₂, bₘ₊₃), respectively, where m=4 k. In an example embodiment, f₁(•) may be set as QPSK mapping only in terms of aₘ, aₘ₊₁ and f₂(•) may be set as QPSK mapping in terms of aₘ₊₂, aₘ₊₃ while f₃(•) is set as 16-QAM in terms of aₘ, aₘ₊₁, bₘ, bₘ₊₁ and f₄(•) is set as 16-QAM in terms of aₘ₊₂, aₘ₊₃, bₘ₊₂, bₘ₊₃. The mapping of proposed MIMO scheme 54 in this embodiment is

$$[ \begin{matrix}{x}_{1} ( n ) & {x}_{1} ( n + 1 ) \\ {x}_{2} ( n ) & {x}_{2} ( n + 1 )\end{matrix} ] = [ \begin{matrix}{s}_{1} ( k ) & - {s}_{4}^{H} ( k ) \\ {s}_{2} ( k ) & {s}_{3}^{H} ( k )\end{matrix} ]$$

where n and n+1 are two different times. The receiver signal that is received at the UE side with two receive antennas can be modeled as

$$[ \begin{matrix}{r}_{1} ( n ) & {r}_{1} ( n + 1 ) \\ {r}_{2} ( n ) & {r}_{2} ( n + 1 )\end{matrix} ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ \begin{matrix}{v}_{1} ( n ) & {v}_{1} ( n + 1 ) \\ {v}_{2} ( n ) & {v}_{2} ( n + 1 )\end{matrix} ]$$

where hᵢⱼ is the channel from the jth antenna at the BS to the ith antenna at the UE and v(k) is additive white Gaussian noise (AWGN).

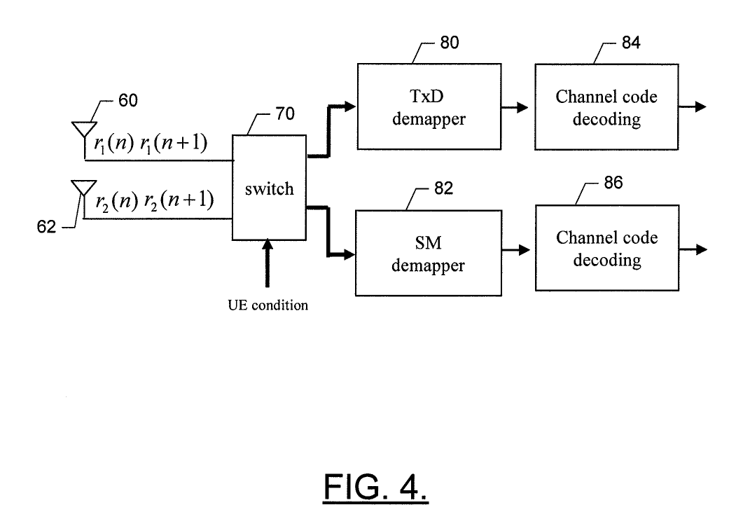

A structure of a receiver that may be employed at the UE is provided in FIG. 4. As shown in FIG. 4, two antennas (60 and 62) may be used to receive the incoming signals. A switch 70 may then be employed based on input indicative of the UE's condition or context with respect to communication conditions such as SINR, error rate performance, the number of antennas, and/or the like. The switch 70 may be configured to determine whether to employ a transmit diversity (T×D) demapper 80 (or detector) or a spatial multiplexing (SM) demapper 82 (or detector) to process the incoming received signals. Channel decoding may thereafter be performed by channel code decoding elements 84 or 86, respectively.

In an example embodiment, the UE can decide (via the switch 70) to use T×D demapper 80 or SM demapper 82 based on the UE condition. As an example, if the UE is in a bad condition, e.g., low SINR or poor error rate performance scenario, the UE can process the received signal in T×D mode and decide to use the T×D demapper 80 to retrieve the soft-value of the base information stream aₘ, aₘ₊₁, aₘ₊₂, aₘ₊₃ by the T×D demapper 80. In an example embodiment, the algorithm employed by the T×D demapper 80 may be as follows such that the UE can first process the received signal as

$${\hat{s}}^{1} ( k ) = [ \begin{matrix}{\hat{s}}_{1}^{1} ( k ) \\ {\hat{s}}_{2}^{1} ( k )\end{matrix} ] = [ \begin{matrix}{h}_{11} & {h}_{12} \\ {h}_{12}^{H} & - {h}_{11}^{H}\end{matrix} ] [ \begin{matrix}{r}_{1} ( n ) \\ {r}_{1}^{H} ( n + 1 )\end{matrix} ]$$

$${\hat{s}}^{2} ( k ) = [ \begin{matrix}{\hat{s}}_{1}^{2} ( k ) \\ {\hat{s}}_{2}^{2} ( k )\end{matrix} ] = [ \begin{matrix}{h}_{21} & {h}_{22} \\ {h}_{22}^{H} & - {h}_{21}^{H}\end{matrix} ] [ \begin{matrix}{r}_{2} ( n ) \\ {r}_{2}^{H} ( n + 1 )\end{matrix} ] ,$$

where ŝ¹(k) and ŝ²(k) are the estimations of s₁(k) and s₂(k) from first antenna and second antenna (60 and 62) at the UE, respectively. Then, the soft-value of âₘ¹ and âₘ² from ŝ¹(k) and ŝ²(k) can be retrieved by the T×D demapper 80, where âₘ¹=[âₘ¹ âₘ₊₁¹ âₘ₊₂¹ âₘ₊₃¹] from first antenna received signal and âₘ²=[âₘ² âₘ₊₁² âₘ₊₂² âₘ₊₃²] from second antenna received signal. The soft-value of âₘ=[âₘ âₘ₊₁ âₘ₊₂ âₘ₊₃] can be obtained by adding âₘ¹ and âₘ², i.e., âₘ=âₘ¹+âₘ².

If the UE is in good condition, e.g., high SINR scenario, or good error rate performance, then the UE can process the received signal in SM mode and decide to use the SM demapper 82 to retrieve both the soft-value of base information stream aₘ, aₘ₊₁, aₘ₊₂, aₘ₊₃ and the enhanced information stream bₘ, bₘ₊₁, bₘ₊₂, bₘ₊₃. The received signal at time index n and n+1 can be written respectively as

$$[ \begin{matrix}{r}_{1} ( n ) \\ {r}_{2} ( n )\end{matrix} ] = [ \begin{matrix}{h}_{11} & {h}_{12} \\ {h}_{21} & {h}_{22}\end{matrix} ] [ \begin{matrix}{x}_{1} ( k ) \\ {x}_{2} ( k )\end{matrix} ] + [ \begin{matrix}{v}_{1} ( n ) \\ {v}_{2} ( n )\end{matrix} ] , and \\ [ \begin{matrix}{r}_{1} ( n + 1 ) \\ {r}_{2} ( n + 1 )\end{matrix} ] = [ \begin{matrix}{h}_{11} & {h}_{12} \\ {h}_{21} & {h}_{22}\end{matrix} ] [ \begin{matrix}{x}_{3} ( k ) \\ {x}_{4} ( k )\end{matrix} ] + [ \begin{matrix}{v}_{1} ( n + 1 ) \\ {v}_{2} ( n + 1 )\end{matrix} ] .$$

This is the standard form of 2×2 MIMO model. The UE can retrieve the soft-value of aₘ, aₘ₊₁, aₘ₊₂, aₘ₊₃ and bₘ, bₘ₊₁, bₘ₊₂, bₘ₊₃ by using any kind of MIMO demapper such as, for example, MMSE, ML, and/or the like.

If the UE is only equipped with one antenna, only the soft-value of the base information stream aₘ, aₘ₊₁, aₘ₊₂, aₘ₊₃ may be retrieved. The received signal at the UE with one antenna can be written as

$$[ {r}_{1} ( n ) {r}_{1} ( n + 1 ) ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ {v}_{1} ( n ) {v}_{1} ( n + 1 ) ] .$$

The algorithm of T×D demapper 80 may be the same as in the UE with two antennas, and may be shown in the following,

$${\hat{s}}^{1} ( k ) = [ \begin{matrix}{\hat{s}}_{1}^{1} ( k ) \\ {\hat{s}}_{2}^{1} ( k )\end{matrix} ] = {[ \begin{matrix}{h}_{11} & {h}_{12} \\ {h}_{12}^{H} & - {h}_{11}^{H}\end{matrix} ]}^{H} [ \begin{matrix}{r}_{1} ( n ) \\ {r}_{1}^{H} ( n + 1 )\end{matrix} ] .$$

The soft-value of âₘ=[âₘ âₘ₊₁ âₘ₊₂ âₘ₊₃] can be retrieved by the T×D demapper 80, based on ŝ¹(k).

The principles described above may be practiced with numerous different mapping and modulation schemes. In other words, in various embodiments, different specific mapping schemes may be employed in connection with hierarchical modulation used to generate two streams of data in which the first stream includes basic information and the second stream includes both basic information and enhanced information. MIMO modulation may then be employed to utilize spatial modulation and transmit diversity to permit selective recovery by the UE based on whether signal robustness or spectral efficiency is preferred for current UE conditions.

Accordingly some embodiments may provide for employing hierarchical modulation to generate a first data stream including basic information and a second data stream including both enhanced information and the basic information, and thereafter employing a MIMO scheme to generate data for transmission, for example, as a MBMS transmission. The data for transmission may employ a combination of spatial multiplexing and transmit diversity techniques to permit selectivity with respect to the recovery technique employed at the receiver end. Embodiments may be employed in connection with multiple combinations of modulation techniques such as, for example, BPSK (binary PSK (phase shift keying)), QPSK (quadrature PSK), 8-PSK, 16QAM (quadrature amplitude modulation), 64QAM and/or the like. Embodiments may also be practiced in connection with transmissions using multiple antennas. In some cases, employing the modulation and MIMO scheme may be performed over multiple codewords.

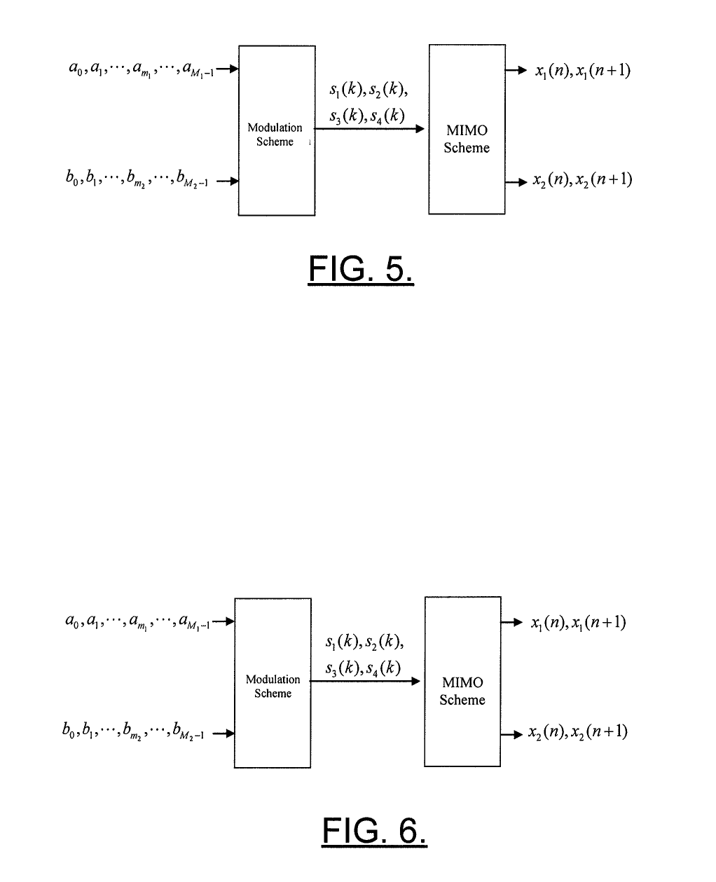

FIGS. 5-12 illustrate examples of different modulation schemes that may be employed for the modulation and MIMO scheme 50 of various example embodiments. As shown in FIG. 5, the modulation scheme may be employed as follows:

s₁(k)=f₁(aₘ_{₁}, aₘ_{₁}₊₁, aₘ_{₁}₊₂, aₘ_{₁}₊₃)
s₂(k)=f₁(aₘ_{₁}₊₄, aₘ_{₁}₊₅, aₘ_{₁}₊₆, aₘ_{₁}₊₇)
s₃(k)=f₂(aₘ_{₁}, aₘ_{₁}₊₁, aₘ_{₁}₊₂, aₘ_{₁}₊₃, bₘ_{₂}, bₘ_{₂}₊₁)
s₄(k)=f₂(aₘ_{₁}₊₄, aₘ_{₁}₊₅, aₘ_{₁}₊₆, aₘ_{₁}₊₇, bₘ_{₂}₊₂, bₘ_{₂}₊₃)
where k=8m₁, or k=4m₂ and M₁=2M₂. In the example above, f₁(•) is 16QAM mapping and f₂(•) is 64QAM mapping. In this example:

$$[ \begin{matrix}{r}_{1} ( n ) & {r}_{1} ( n + 1 ) \\ {r}_{2} ( n ) & {r}_{2} ( n + 1 )\end{matrix} ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ \begin{matrix}{v}_{1} ( n ) & {v}_{1} ( n + 1 ) \\ {v}_{2} ( n ) & {v}_{2} ( n + 1 )\end{matrix} ] \\ [ \begin{matrix}{x}_{1} ( n ) & {x}_{1} ( n + 1 ) \\ {x}_{2} ( n ) & {x}_{2} ( n + 1 )\end{matrix} ] = [ \begin{matrix}{s}_{1} ( k ) & - {s}_{4}^{H} ( k ) \\ {s}_{2} ( k ) & {s}_{3}^{H} ( k )\end{matrix} ] .$$

As shown in FIG. 6, the modulation scheme may be employed as follows:

s₁(k)=f₁(aₘ_{₁}, aₘ_{₁}₊₁, aₘ_{₁}₊₂, aₘ_{₁}₊₃)
s₂(k)=f₁(aₘ_{₁}₊₄, aₘ_{₁}₊₅, aₘ_{₁}₊₆, aₘ_{₁}₊₇)
s₃(k)=f₂(aₘ_{₁}, aₘ_{₁}₊₁, bₘ_{₂}, bₘ_{₂}₊₁, bₘ_{₂}₊₃, bₘ_{₂}₊₄)
s₄(k)=f₂(aₘ_{₁}₊₄, aₘ_{₁}₊₅, bₘ_{₂}₊₆, bₘ_{₂}₊₇, bₘ_{₂}₊₈)
where k=8m₁, or k=8m₂ and M₁=M₂. In the example above, f₁(•) is 16QAM mapping and f₂(•) is 64QAM mapping. In this example:

$$[ \begin{matrix}{r}_{1} ( n ) & {r}_{1} ( n + 1 ) \\ {r}_{2} ( n ) & {r}_{2} ( n + 1 )\end{matrix} ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ \begin{matrix}{v}_{1} ( n ) & {v}_{1} ( n + 1 ) \\ {v}_{2} ( n ) & {v}_{2} ( n + 1 )\end{matrix} ] \\ [ \begin{matrix}{x}_{1} ( n ) & {x}_{1} ( n + 1 ) \\ {x}_{2} ( n ) & {x}_{2} ( n + 1 )\end{matrix} ] = [ \begin{matrix}{s}_{1} ( k ) & - {s}_{4}^{H} ( k ) \\ {s}_{2} ( k ) & {s}_{3}^{H} ( k )\end{matrix} ] .$$

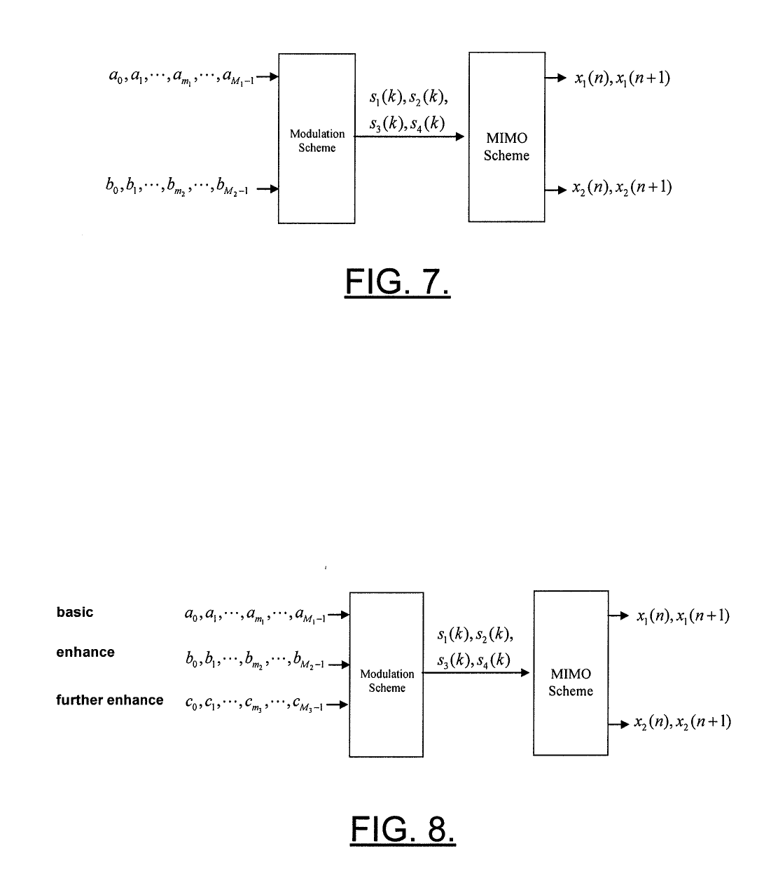

As shown in FIG. 7, the modulation scheme may be employed as follows:

s₁(k)=f₁(aₘ_{₁}, aₘ_{₁}₊₁, aₘ_{₁}₊₂, aₘ_{₁}₊₃)
s₂(k)=f₁(aₘ_{₁}₊₄, aₘ_{₁}₊₅, aₘ_{₁}₊₆, aₘ_{₁}₊₇)
s₃(k)=f₂(aₘ_{₁}, aₘ_{₁}₊₁, bₘ_{₂}, bₘ_{₂}₊₁)
s₄(k)=f₂(aₘ_{₁}₊₄, aₘ_{₁}₊₅, bₘ_{₂}₊₂, bₘ_{₂}₊₃)
where k=8m₁ or k=4m₂ and M₁=2M₂. In the example above, f₁(•) is 16QAM mapping and f₂(•) is 16QAM mapping. In this example:

$$[ \begin{matrix}{r}_{1} ( n ) & {r}_{1} ( n + 1 ) \\ {r}_{2} ( n ) & {r}_{2} ( n + 1 )\end{matrix} ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ \begin{matrix}{v}_{1} ( n ) & {v}_{1} ( n + 1 ) \\ {v}_{2} ( n ) & {v}_{2} ( n + 1 )\end{matrix} ] \\ [ \begin{matrix}{x}_{1} ( n ) & {x}_{1} ( n + 1 ) \\ {x}_{2} ( n ) & {x}_{2} ( n + 1 )\end{matrix} ] = [ \begin{matrix}{s}_{1} ( k ) & - {s}_{4}^{H} ( k ) \\ {s}_{2} ( k ) & {s}_{3}^{H} ( k )\end{matrix} ] .$$

As shown in FIG. 8, the modulation scheme may sometimes operate with respect to enhancement information and further enhancement information cₘ. In such examples, the modulation scheme may be employed as follows:

s₁(k)=f₁(aₘ_{₁}, aₘ_{₁}₊₁)
s₂(k)=f₁(bₘ_{₂}, bₘ_{₂}₊₁)
s₃(k)=f₂(aₘ_{₁}, aₘ_{₁}₊₁, cₘ_{₃}, cₘ_{₃}₊₁)
s₄(k)=f₂(bₘ_{₂}, bₘ_{₂}₊₁, cₘ_{₃}, cₘ_{₃}₊₁)
where k=2m₁, or k=2m₂, or k=2m₃ and M₁=M₂=M₃. In the example above, f₁(•) is 16QAM mapping and f₂(•) is 16QAM mapping. In this example:

$$[ \begin{matrix}{r}_{1} ( n ) & {r}_{1} ( n + 1 ) \\ {r}_{2} ( n ) & {r}_{2} ( n + 1 )\end{matrix} ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ \begin{matrix}{v}_{1} ( n ) & {v}_{1} ( n + 1 ) \\ {v}_{2} ( n ) & {v}_{2} ( n + 1 )\end{matrix} ] \\ [ \begin{matrix}{x}_{1} ( n ) & {x}_{1} ( n + 1 ) \\ {x}_{2} ( n ) & {x}_{2} ( n + 1 )\end{matrix} ] = [ \begin{matrix}{s}_{1} ( k ) & - {s}_{4}^{H} ( k ) \\ {s}_{2} ( k ) & {s}_{3}^{H} ( k )\end{matrix} ] .$$

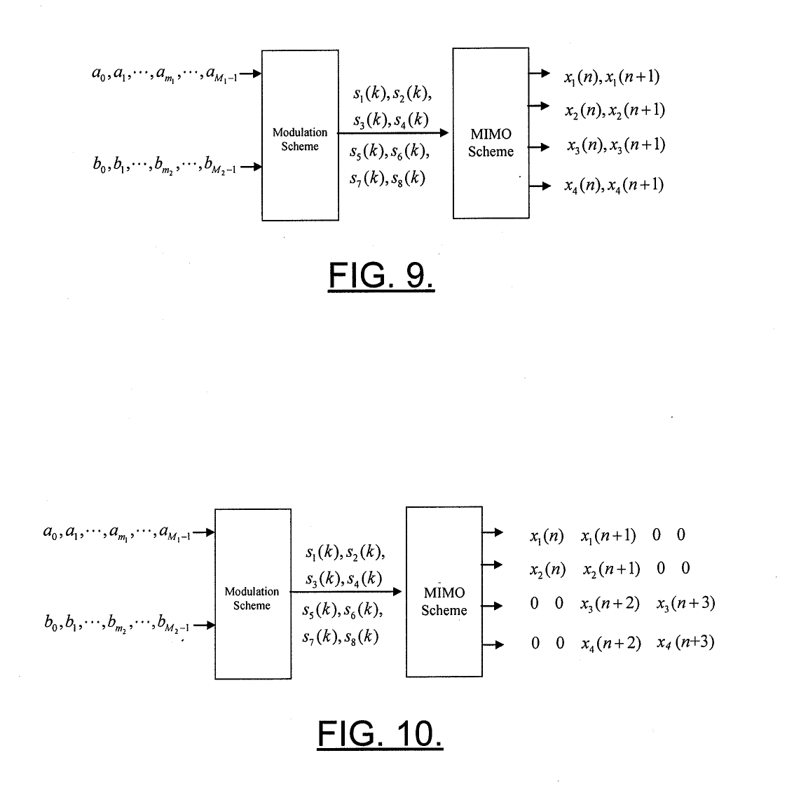

As shown in FIG. 9, the modulation scheme may be employed as follows:

s₁(k)=f₁(aₘ_{₁}, aₘ_{₁}₊₁)
s₂(k)=f₁(aₘ_{₁}₊₂, aₘ_{₁}₊₃)
s₃(k)=f₂(aₘ_{₁}, aₘ_{₁}₊₁, bₘ_{₂}, bₘ_{₂}₊₁)
s₄(k)=f₂(aₘ_{₁}₊₂, aₘ_{₁}₊₃, bₘ_{₂}₊₂, bₘ_{₂}₊₃)
s₅(k)=f₁(aₘ_{₁}₊₄, aₘ_{₁}₊₅)
s₆(k)=f₁(aₘ_{₁}₊₆, aₘ_{₁}₊₇)
s₇(k)=f₂(aₘ_{₁}₊₄, aₘ_{₁}₊₅, bₘ_{₂}₊₄, bₘ_{₂}₊₅)
s₈(k)=f₂(aₘ_{₁}₊₆, aₘ_{₁}₊₇, bₘ_{₂}₊₆, bₘ_{₂}₊₇)
where k=8m₁, or k=8m₂, and M₁=M₂. In the example above, f₁(•) is QPSK mapping and f₂(•) is 16QAM mapping. In this example:

$$[ \begin{matrix}{x}_{1} ( n ) & {x}_{1} ( n + 1 ) \\ {x}_{2} ( n ) & {x}_{2} ( n + 1 ) \\ {x}_{3} ( n ) & {x}_{3} ( n + 1 ) \\ {x}_{4} ( n ) & {x}_{4} ( n + 1 )\end{matrix} ] = [ \begin{matrix}{s}_{1} ( k ) & - {s}_{4}^{H} ( k ) \\ {s}_{2} ( k ) & {s}_{3}^{H} ( k ) \\ {s}_{4} ( k ) & - {s}_{6}^{H} ( k ) \\ {s}_{5} ( k ) & {s}_{7}^{H} ( k )\end{matrix} ] .$$

As shown in FIG. 10, the modulation scheme may be employed as follows:

s₁(k)=f₁(aₘ_{₁}, aₘ_{₁}₊₁)
s₂(k)=f₁(aₘ_{₁}₊₂, aₘ_{₁}₊₃)
s₃(k)=f₂(aₘ_{₁}, aₘ_{₁}₊₁, bₘ_{₂}, bₘ_{₂}₊₁)
s₄(k)=f₂(aₘ_{₁}₊₂, aₘ_{₁}₊₃, bₘ_{₂}₊₂, bₘ_{₂}₊₃)
s₅(k)=f₁(aₘ_{₁}₊₄, aₘ_{₁}₊₅)
s₆(k)=f₁(aₘ_{₁}₊₆, aₘ_{₁}₊₇)
s₇(k)=f₂(aₘ_{₁}₊₄, aₘ_{₁}₊₅, bₘ_{₂}₊₄, bₘ_{₂}₊₅)
s₈(k)=f₂(aₘ_{₁}₊₆, aₘ_{₁}₊₇, bₘ_{₂}₊₆, bₘ_{₂}₊₇)
where k=8m₁, or k=8m₂, and M₁=M₂. In the example above, f₁(•) is QPSK mapping and f₂(•) is 16QAM mapping. In this example:

$$[ \begin{matrix}{x}_{1} ( n ) & {x}_{1} ( n + 1 ) & 0 & 0 \\ {x}_{2} ( n ) & {x}_{2} ( n + 1 ) & 0 & 0 \\ 0 & 0 & {x}_{3} ( n + 2 ) & {x}_{3} ( n + 3 ) \\ 0 & 0 & {x}_{4} ( n + 2 ) & {x}_{4} ( n + 3 )\end{matrix} ] = [ \begin{matrix}{s}_{1} ( k ) & - {s}_{4}^{H} ( k ) & 0 & 0 \\ {s}_{2} ( k ) & {s}_{3}^{H} ( k ) & 0 & 0 \\ 0 & 0 & {s}_{4} ( k ) & - {s}_{6}^{H} ( k ) \\ 0 & 0 & {s}_{5} ( k ) & {s}_{7}^{H} ( k )\end{matrix} ] .$$

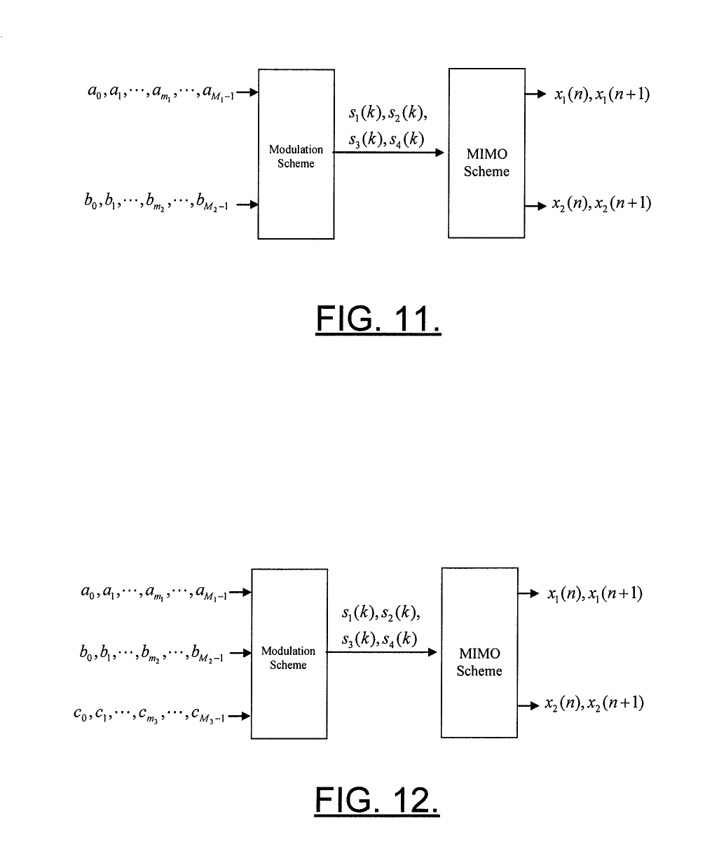

As shown in FIG. 11, in some embodiments the modulation scheme may be employed as follows:

s₃(k)=f₁(aₘ_{₁}, aₘ_{₁}₊₁, bₘ_{₂}₊₂, bₘ_{₂}₊₃)
s₁(k)=f₁(aₘ_{₁}, aₘ_{₁}₊₁, bₘ_{₂}, bₘ_{₂}₊₁)
s₂(k)=f₁(aₘ_{₁}₊₂, aₘ_{₁}₊₃, bₘ_{₂}₊₅, bₘ_{₂}₊₆)
s₄(k)=f₁(aₘ_{₁}₊₂, aₘ_{₁}₊₃, bₘ_{₂}₊₇, bₘ_{₂}₊₈)
where k=4m₁, or k=8m₂, and 2M₁=M₂. In the example above, f₁(•) is 16QAM mapping and f₂(•) is 16QAM mapping. In this example:

$$[ \begin{matrix}{r}_{1} ( n ) & {r}_{1} ( n + 1 ) \\ {r}_{2} ( n ) & {r}_{2} ( n + 1 )\end{matrix} ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ \begin{matrix}{v}_{1} ( n ) & {v}_{1} ( n + 1 ) \\ {v}_{2} ( n ) & {v}_{2} ( n + 1 )\end{matrix} ] \\ [ \begin{matrix}{x}_{1} ( n ) & {x}_{1} ( n + 1 ) \\ {x}_{2} ( n ) & {x}_{2} ( n + 1 )\end{matrix} ] = [ \begin{matrix}{s}_{1} ( k ) & - {s}_{4}^{H} ( k ) \\ {s}_{2} ( k ) & {s}_{3}^{H} ( k )\end{matrix} ] .$$

As shown in FIG. 12, in some embodiments the modulation scheme may be employed as follows:

s₃(k)=f₁(aₘ_{₁}, aₘ_{₁}₊₁, cₘ_{₃}, cₘ_{₃}₊₁)
s₁(k)=f₁(aₘ_{₁}, aₘ_{₁}₊₁, bₘ_{₂}, bₘ_{₂}₊₁)
s₂(k)=f₁(aₘ_{₁}₊₂, aₘ_{₁}₊₃, bₘ_{₂}₊₂, bₘ_{₂}₊₃)
s₄(k)=f₁(aₘ_{₁}₊₂, aₘ_{₁}₊₃, cₘ_{₃}₊₂, cₘ_{₃}₊₃)
where k=4m₁, or k=4m₂, or k=4m₃, and M₁=M₂=M₃. In the example above, f₁(•) is 16QAM mapping and f₂(•) is 16QAM mapping. In this example:

$$[ \begin{matrix}{r}_{1} ( n ) & {r}_{1} ( n + 1 ) \\ {r}_{2} ( n ) & {r}_{2} ( n + 1 )\end{matrix} ] = [ \begin{matrix}{h}_{11} & {h}_{12} \\ {h}_{21} & {h}_{22}\end{matrix} ] [ \begin{matrix}{s}_{1} ( k ) & - {s}_{4}^{H} ( k ) \\ {s}_{2} ( k ) & {s}_{3}^{H} ( k )\end{matrix} ] + [ \begin{matrix}{v}_{1} ( n ) & {v}_{1} ( n + 1 ) \\ {v}_{2} ( n ) & {v}_{2} ( n + 1 )\end{matrix} ] \\ [ \begin{matrix}{x}_{1} ( n ) & {x}_{1} ( n + 1 ) \\ {x}_{2} ( n ) & {x}_{2} ( n + 1 )\end{matrix} ] = [ \begin{matrix}{s}_{1} ( k ) & - {s}_{4}^{H} ( k ) \\ {s}_{2} ( k ) & {s}_{3}^{H} ( k )\end{matrix} ] .$$

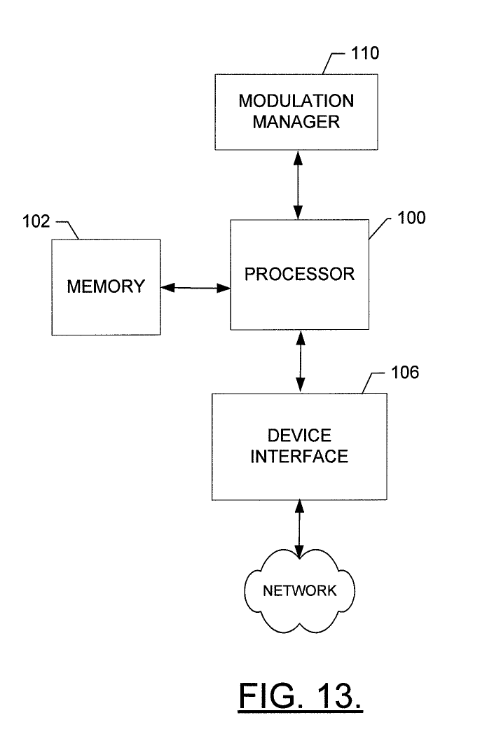

FIG. 13 illustrates an example of an apparatus according to an exemplary embodiment. The apparatus may include or otherwise be in communication with a processor 100, a memory 102, and a device interface 106. The memory 102 may include, for example, volatile and/or non-volatile memory. The memory 102 may be a computer-readable storage medium. The memory 102 may be distributed. That is, portions of memory 102 may be removable or non-removable. In some embodiments, memory 102 may be implemented in a transmitting device (e.g., a BS or other transmission station). The memory 102 may be configured to store information, data, applications, instructions or the like for enabling the apparatus to carry out various functions in accordance with exemplary embodiments of the disclosure. For example, the memory 102 could be configured to buffer input data for processing by the processor 100 and/or store instructions for execution by the processor 100.

The processor 100 may be embodied in a number of different ways. For example, the processor 100 may be embodied as various processing means such as processing circuitry embodied as a coprocessor, a controller or various other processing devices including integrated circuits such as, for example, an ASIC (application specific integrated circuit), embedded processor, an FPGA (field programmable gate array), a hardware accelerator, a microcontroller, or the like. In an exemplary embodiment, the processor 100 may be configured to execute data or instructions stored in the memory 102 or otherwise accessible to the processor 100.

Meanwhile, the device interface 106 may be any means such as a device or circuitry embodied in either hardware, software, or a combination of hardware and software that is configured to receive and/or transmit data from/to a network and/or any other device or module in communication with the apparatus. In this regard, the device interface 106 may include, for example, an antenna (or multiple antennas) and supporting hardware and/or software to encode/decode, modulate/demodulate, and to perform other wireless communication channel-related functions for enabling communications with a wireless communication network. In fixed environments, the device interface 106 may alternatively or also support wired communication. As such, the device interface 106 may include a communication modem and/or other hardware/software for supporting communication via cable, digital subscriber line (DSL), universal serial bus (USB), Ethernet, FireWire®, or other mechanisms.

In an exemplary embodiment, the processor 100 may be embodied as, include or otherwise control a modulation manager 110. The modulation manager 110 may be any means such as a device or circuitry embodied in hardware, software or a combination of hardware and software (e.g., processor 100 operating under software control) that is configured to perform the corresponding functions of the modulation manager 110, as described below.

In an exemplary embodiment, the modulation manager 110 may operate responsive to execution of instructions, code, modules, applications and/or circuitry for employing hierarchical modulation to generate a first data stream including basic information and a second data stream including both enhanced information and the basic information, and employing a modulation and multiple input/multiple output (MIMO) scheme to generate data for transmission. The data for transmission may employ a combination of spatial multiplexing and transmit diversity techniques.

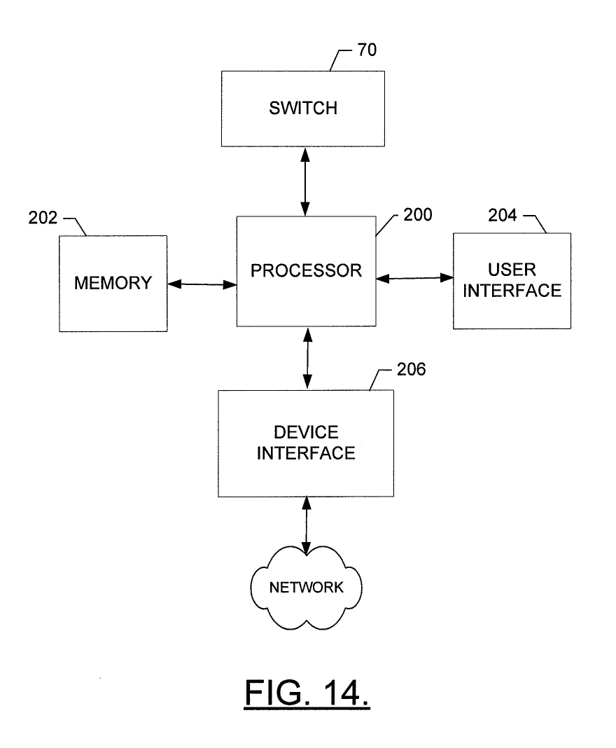

FIG. 14 illustrates a block diagram of a receiver side apparatus (e.g., a mobile terminal receiving a transmission) for employing an embodiment of the present application. The apparatus may include or otherwise be in communication with a processor 200, a memory 202, a user interface 204 and a device interface 206. The memory 202 may include, for example, volatile and/or non-volatile memory (i.e., non-transitory storage medium or media) and may be configured to store information, data, applications, instructions or the like for enabling the processor 200 to carry out various functions in accordance with exemplary embodiments of the present application. For example, the memory 202 may be configured to buffer input data for processing by the processor 200 and/or store instructions for execution by the processor 200.

The processor 200 may be embodied in a number of different ways. For example, the processor 200 may be embodied as various processing means such as processing circuitry embodied as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 200 may be configured to execute instructions stored in the memory 202 or otherwise accessible to the processor 200. As such, the processor 200 may be configured to cause various functions to be executed either by execution of instructions stored in the memory 202 or by executing other preprogrammed functions.

The user interface 204 may be in communication with the processor 200 to receive an indication of a user input at the user interface 204 and/or to provide an audible, visual, mechanical or other output to the user. As such, the user interface 204 may include, for example, a keyboard, a mouse, a joystick, a display, a touch screen, soft keys, a microphone, a speaker, or other input/output mechanisms.

Meanwhile, the device interface 206 may be any means such as a device or circuitry embodied in either hardware, software, or a combination of hardware and software that is configured to receive and/or transmit data from/to a network and/or any other device or module in communication with the apparatus. In this regard, the device interface 206 may include, for example, an antenna (or multiple antennas) and supporting hardware and/or software for enabling communications with a wireless communication network. In fixed environments, the device interface 206 may alternatively or also support wired communication. As such, the device interface 206 may include a communication modem and/or other hardware/software for supporting communication via cable, digital subscriber line (DSL), universal serial bus (USB) or other mechanisms.

In an exemplary embodiment, the processor 200 may be embodied as, include or otherwise control the switch 70. The switch 70 may be any means such as a device or circuitry embodied in hardware, software or a combination of hardware and software (e.g., processor 200 operating under software control) that is configured to perform the corresponding functions of the switch 70 as described below.

In an exemplary embodiment, the switch may operate responsive to execution of instructions, code, modules, applications and/or circuitry for selective recovery of received data at a mobile terminal. The switch 70 may therefore be configured to cause receiving data via at least two antennas at a mobile terminal, receiving information indicative of a data reception condition at the mobile terminal, and determining, between spatial multiplexing and transmit diversity mode options, a reception mode to be employed for decoding the data received based on the information indicative of the data reception condition.

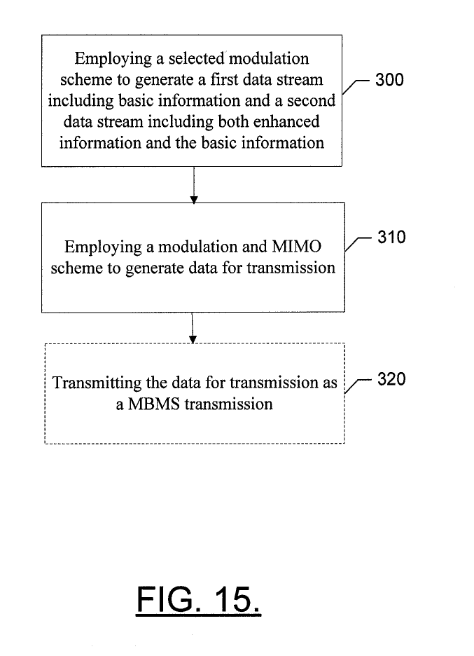

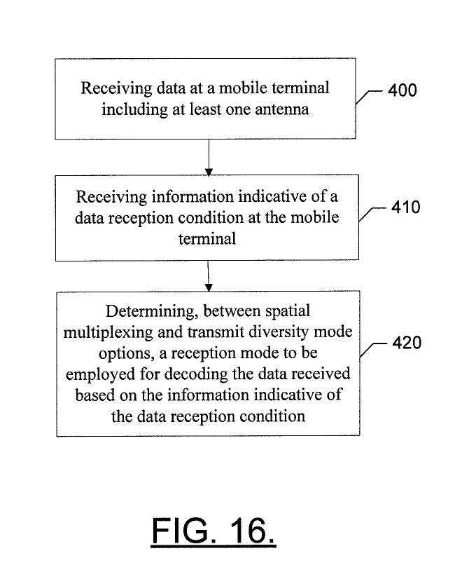

FIGS. 15 and 16 are flowcharts of a system, method and program product according to exemplary embodiments of the application. It will be understood that each block of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory and executed by a processor. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s). These computer program instructions may also be stored in a computer-readable electronic storage memory that can direct a computer or other programmable apparatus to function in a particular manner, such that the instructions stored in the computer-readable memory produce an article of manufacture including instruction means which implement the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions, combinations of operations for performing the specified functions and program instruction means for performing the specified functions. It will also be understood that one or more blocks of the flowcharts, and combinations of blocks in the flowcharts, can be implemented by special purpose hardware-based computer systems which perform the specified functions or operations, or combinations of special purpose hardware and computer instructions.

In this regard, one embodiment of a method for providing multi-resolution transmission with a MIMO scheme as provided in FIG. 15 may include employing a selected modulation scheme (e.g., hierarchical modulation or some other type of modulation) to generate a first data stream including basic information (without enhanced information) and a second data stream including both enhanced information and the basic information at operation 300. The method may further include employing, e.g., via a processor, a modulation and multiple input/multiple output (MIMO) scheme to generate data for transmission at operation 310. The data for transmission may employ a combination of spatial multiplexing and transmit diversity techniques.

In some embodiments, certain ones of the operations above may be modified or further amplified as described below. Moreover, in some cases, the method may include additional optional operations (an example of which is indicated in dashed lines in FIG. 15). It should be appreciated that each of the modifications or amplifications below may be included with the operations above either alone or in combination with any others among the features described herein. In this regard, for example, the method may further include transmitting the data for transmission as a Multimedia Broadcast Multicast Service (MBMS) transmission at operation 320. In some embodiments, transmitting the data may include transmitting the data using multiple antennas. In some cases, employing the modulation and MIMO scheme may include employing a combination of modulation techniques including one or more of BPSK, QPSK, 8-PSK, 16QAM or 64QAM. In an example embodiment, employing the modulation and MIMO scheme may include employing the modulation and MIMO scheme over multiple codewords.

In an exemplary embodiment, an apparatus for performing the method of FIG. 15 above may comprise a processor (e.g., the processor 100) configured to perform some or each of the operations (300-320) described above. The processor may, for example, be configured to perform the operations (300-320) by performing hardware implemented logical functions, executing stored instructions, or executing algorithms for performing each of the operations.

In another example embodiment, a method for providing selective recovery of received data at a mobile terminal as provided in FIG. 16 may include receiving data at a mobile terminal including at least one antenna at operation 400, receiving information indicative of a data reception condition at the mobile terminal at operation 410, and determining, between spatial multiplexing and transmit diversity mode options, a reception mode to be employed for decoding the data received based on the information indicative of the data reception condition at operation 420.

In some embodiments, certain ones of the operations above may be modified or further amplified as described below. It should be appreciated that each of the modifications or amplifications below may be included with the operations above either alone or in combination with any others among the features described herein. In this regard, for example, receiving the data may include receiving the data responsive to a Multimedia Broadcast Multicast Service (MBMS) transmission. In some embodiments, receiving information indicative of the data reception condition may include receiving information indicative of a number of antennas, receiving a signal to noise plus interference (SINR) at the mobile terminal, and/or receiving information indicative of an error rate performance of the mobile terminal.

In an exemplary embodiment, an apparatus for performing the method of FIG. 16 above may comprise a processor (e.g., the processor 200) configured to perform some or each of the operations (400-420) described above. The processor may, for example, be configured to perform the operations (400-420) by performing hardware implemented logical functions, executing stored instructions, or executing algorithms for performing each of the operations.

Many modifications and other embodiments of the applications set forth herein will come to mind to one skilled in the art to which these applications pertain having the benefit of the teachings presented in the foregoing descriptions and the associated drawings. Therefore, it is to be understood that the applications are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
employing a selected modulation scheme to generate a first data stream including basic information and a second data stream including both enhanced information and the basic information; and
employing, via a processor, a modulation and multiple input/multiple output (MIMO) scheme to generate data for transmission, the data for transmission employing a combination of spatial multiplexing and transmit diversity techniques.

2. The method of claim 1, further comprising transmitting the data for transmission as a Multimedia Broadcast Multicast Service (MBMS) transmission.

3. The method of claim 2, wherein transmitting the data comprises transmitting the data using multiple antennas.

4. The method of claim 1, wherein employing the modulation and MIMO scheme comprises employing a combination of modulation techniques including one or more of BPSK (binary phase shift keying), QPSK (quadrature phase shift keying), 8-PSK, 16QAM (quadrature amplitude modulation) or 64QAM.

5. The method of claim 1, wherein employing the modulation and MIMO scheme comprises employing the modulation and MIMO scheme over multiple codewords.

6. The method of claim 1, wherein employing the selected modulation scheme comprises employing hierarchical modulation.

7. An apparatus comprising a processor configured to cause performance of at least:
employing a selected modulation scheme to generate a first data stream including basic information and a second data stream including both enhanced information and the basic information; and
employing a modulation and multiple input/multiple output (MIMO) scheme to generate data for transmission, the data for transmission employing a combination of spatial multiplexing and transmit diversity techniques.

8. The apparatus of claim 7, wherein the processor is further configured to cause transmitting the data for transmission as a Multimedia Broadcast Multicast Service (MBMS) transmission.

9. The apparatus of claim 8, wherein the processor is further configured to cause transmitting the data using multiple antennas.

10. The apparatus of claim 7, wherein the processor is further configured to cause employing the modulation and MIMO scheme including employing a combination of modulation techniques including one or more of BPSK (binary phase shift keying), QPSK (quadrature phase shift keying), 8-PSK, 16QAM (quadrature amplitude modulation) or 64QAM.

11. The apparatus of claim 7, wherein the processor is further configured to cause employing the modulation and MIMO scheme including employing the modulation and MIMO scheme over multiple codewords.

12. The apparatus of claim 7, wherein the processor is further configured to employ the selected modulation scheme by employing hierarchical modulation.

13. A method comprising:
receiving data at a mobile terminal including at least one antenna;
receiving information indicative of a data reception condition at the mobile terminal; and
determining, between spatial multiplexing and transmit diversity mode options, a reception mode to be employed for decoding the data received based on the information indicative of the data reception condition.

14. The method of claim 13, wherein receiving the data comprises receiving the data responsive to a Multimedia Broadcast Multicast Service (MBMS) transmission.

15. The method of claim 13, wherein receiving information indicative of the data reception condition comprises receiving information indicative of a number of antennas.

16. The method of claim 13, wherein receiving information indicative of the data reception condition comprises receiving information indicative of a signal to noise plus interference (SINR) at the mobile terminal.

17. The method of claim 13, wherein receiving information indicative of the data reception condition comprises receiving information indicative of an error rate performance of the mobile terminal.

18. An apparatus comprising a processor configured to cause performance of at least:
receiving data at a mobile terminal including at least one antenna;
receiving information indicative of a data reception condition at the mobile terminal; and
determining, between spatial multiplexing and transmit diversity mode options, a reception mode to be employed for decoding the data received based on the information indicative of the data reception condition.

19. The apparatus of claim 18, wherein the processor being configured to cause receiving the data comprises the processor being configured to cause receiving the data responsive to a Multimedia Broadcast Multicast Service (MBMS) transmission.

20. The apparatus of claim 18, wherein the processor being configured to cause receiving information indicative of the data reception condition comprises the processor being configured to cause receiving information indicative of a number of antennas.

21. The apparatus of claim 18, wherein the processor being configured to cause receiving information indicative of the data reception condition comprises the processor being configured to cause receiving information indicative of a signal to noise plus interference (SINR) at the mobile terminal.

22. The apparatus of claim 18, wherein the processor being configured to cause receiving information indicative of the data reception condition comprises the processor being configured to cause receiving information indicative of an error rate performance of the mobile terminal.
